(19) United States
(12) Patent Application Publication
(10) Pub. No.: US 2024/0018392 A1
(43) Pub. Date: Jan. 18, 2024

(54) Adhesive Composition

(71) Applicants: Dow Global Technologies LLC, Midland, MI (US); Rohm and Haas Company, Collegeville, PA (US)

(72) Inventors: Elodie Hablot, Horgen (CH); Chenyan Bai, Shanghai (CN); Jie Wu, Lake Jackson, TX (US); Thorsten Schmidt, Horgen (CH); Joseph J. Zupancic, Glen Ellyn, IL (US); Daniele Vinci, Horgen (CH); Marco Frasconi, Mozzate (IT)

(21) Appl. No.: 18/251,446

(22) PCT Filed: Nov. 3, 2020
(86) PCT No.: PCT/CN2020/126211

§ 371 Date: May 2, 2023

(51) Int. Cl. C09J 5/04; C09J 175/04; C08L 75/04; C08G 18/48; C08G 18/42; C08G 18/72; C08G 18/76; C08G 18/40; B32B 15/09; B32B 15/20; B32B 27/36; B32B 27/08; B32B 27/32; B32B 27/30; B32B 27/34; B32B 7/12; B32B 37/12

(52) U.S. Cl. CPC C09J 5/04; C09J 175/04; C08L 75/04; C08G 18/4816; C08G 18/4202; C08G 18/728; C08G 18/4213; C08G 18/7671; C08G 18/4829; C08G 18/4018; B32B 15/09; B32B 15/20; B32B 27/36; B32B 27/08; B32B 27/32; B32B 27/306; B32B 27/34; B32B 7/12; B32B 37/1284; C09J 2475/006; C09J 2467/006; C09J 2471/006; B32B 2270/00; B32B 2250/02; B32B 2037/1253

(57) ABSTRACT

A two-component solventless laminating adhesive composition including: (A) at least one isocyanate component comprising at least one isocyanate; and (B) at least one polyol component comprising: (Bi) at least one amine-initiated polyol; (Bii) at least one aliphatic polyester polyol; and (Biii) at least one polyether polyol; a process for preparing the above solventless adhesive laminating composition; and a laminate structure made using the above solventless adhesive laminating composition.

### FIELD

The present invention relates to a two-component, solventless polyurethane-based laminating adhesive composition; and to laminates produced using the two-component, solventless polyurethane-based laminating adhesive composition.

### BACKGROUND

Adhesive compositions are useful for a wide variety of purposes. For instance, adhesive compositions are used to bond together substrates such as polyethylene, polypropylene, polyester, polyamide, metal, metallized, paper, or cellophane to form composite films, i.e., laminates. The use of adhesives in different end-use applications is generally known. For example, adhesives can be used in the manufacture of film/film and film/foil laminates used in the packaging industry, especially for food packaging. Adhesives used in laminating applications, or “laminating adhesives,” can be generally placed into three categories: solvent-based, water-based, and solventless. The performance of an adhesive varies by category and by the application in which the adhesive is applied.

Solventless laminating adhesives can be applied up to one hundred percent solids without either organic solvent or an aqueous carrier. Because no organic solvent or water has to be dried from the adhesive upon application, these adhesives can be run at high line speeds and are preferable in applications requiring quick adhesive application. Solvent and water-based laminating adhesives are limited by the rate at which the solvent or water can be effectively dried and removed from the laminate structure after application of the adhesive. For environmental, health, and safety reasons, laminating adhesives are preferably aqueous or solventless.

Within the category of solventless laminating adhesives, there are many varieties. One particular variety includes premixed, two-component, polyurethane-based laminating adhesives. Typically, a two-component polyurethane-based laminating adhesive includes a first component comprising an isocyanate-containing prepolymer and/or a polyisocyanate and a second component comprising a polyol. The prepolymer can be obtained by the reaction of excess isocyanate with a polyether polyol and/or polyester polyol containing two or more hydroxyl groups per molecule. The second component comprises a polyether polyol and/or polyester polyol initiated with two or more hydroxyl groups per molecule. The two components are combined in a predetermined ratio, or “premixed,” and then applied on a first substrate (“carrier web”). The first substrate is then brought together with a second substrate to form a laminate structure.

Additional layers of substrate can be added to the structure with additional layers of adhesive composition located between each successive substrate. The adhesive is then cured, either at room temperature or elevated temperature, thereby bonding the substrates together.

Further processing of the laminate structure depends upon the curing speed of the adhesive. The curing speed of the adhesive is indicated by the time in which the mechanical bond between the laminated substrates takes to become sufficient to allow for further processing and the laminate is in compliance with applicable regulations (e.g., food contact regulations). Slow curing speed results in lower conversion efficiency. Premixed two-component solventless laminating adhesives, compared to traditional solvent-containing adhesives, exhibit weak initial bonds and slow curing speed. The general trend in the converting industry is towards faster curing laminating adhesives. Faster curing improves the operational efficiency for converters. Specifically, quickly moving finished products out of a warehouse increases production capacity and flexibility for handling last minute orders (e.g., retailer promotional campaigns). In order to increase operational efficiency, an adhesive composition with a reactivity much higher than existing adhesive compositions should be used to form laminates. However, such adhesive compositions have demonstrated limitations when used in laminate structures comprising metal and/or metallized substrates. At relatively-high line speeds (e.g., in excess of 250 meters per minute [m/min]), defects in the produced laminates can be visually observed. The defects are attributable to, inter alia, wettability failures and air entrainment during the lamination process.

Accordingly, two-component solventless polyurethane-based laminating adhesive compositions with improved bond strength, faster curing speeds, and enhanced adhesion to metal and/or metallized substrates are desirable.

In addition, it is desirable to provide an adhesive formulation that is prepared without having to premix the two components of the adhesive formulation and applying the entire adhesive formulation mixture onto a carrier web before the carrier web is brought in contact with the second substrate as done using conventional laminating equipment. To avoid premixing, it is known apply the two components of an adhesive as two separate adhesive components to two separate film substrates, for example, by applying a first adhesive component onto the surface of a first film and applying a second adhesive component (separate and apart from the first adhesive component) onto the surface of a second film; and then bringing the two substrates together. Since the first adhesive component is reactive with the second adhesive component, when the two components on the two films are brought in contact with each other, the combined two reactants form a reactive adhesive formulation which reacts to bond the two films together via the reacted adhesive formulation.

Generally, a “one-shot lamination” process which utilizes certain specific laminating equipment (e.g., a one-shot laminator) is used to carry out the step of bringing the two films containing the two separate components of the adhesive formulation together to form a laminate. Typically, the one-shot lamination laminator operates at high line speeds (e.g., greater than or equal to 200 m/min) to carry out the application step. However, some of the drawbacks of using the previously known two-component, solventless polyurethane-based laminating adhesive compositions with the one-shot lamination process/equipment include, for example, poor metal adhesion, poor chemical/product resistance, short pot life, and poor stability due to phase separation.

It is therefore desired to provide a suitable two-component solventless polyurethane-based laminating adhesive composition for use in a one-shot lamination process/equipment, to produce a multilayer laminate, that overcomes the above disadvantages, limitations, and defects of previously known solventless adhesive formulations.

### SUMMARY

One embodiment of the present invention is directed to a two-component solventless laminating adhesive composition including: (A) at least one isocyanate component comprising at least one isocyanate; and (B) at least one polyol component comprising: (Bi) at least one amine-initiated polyol; (Bii) at least one aliphatic polyester polyol; and (Biii) at least one polyether polyol.

Another embodiment of the present invention is directed to a process for preparing the above solventless adhesive laminating composition.

Still other embodiments of the present invention include a laminate structure made using the above solventless adhesive laminating composition; and a process for producing the above laminate structure.

### DETAILED DESCRIPTION

In the art of adhesives, a two-part (i.e., a two-component) adhesive system or adhesive composition includes a first reactant (or first part) comprising an isocyanate component (herein “Component A”), and a second reactant (or second part) comprising a polyol component (herein “Component B”). Combining or mixing Component A and Component B forms the two-part reaction mixture adhesive composition. In one broad embodiment, the present invention is directed to a two-component solventless laminating adhesive composition (herein abbreviated “SLAC”) for producing a laminate including at least one isocyanate component, Component A, and at least one polyol component, Component B.

The SLAC of the present invention is particularly suitable for use in laminate structures comprising metal or metallized substrates. The SLAC exhibits a fast curing rate relative to existing two-component solventless adhesive compositions when used in laminate structures including metal and/or metallized substrates. Because the SLAC is formulated to be more highly reactive and exhibits a fast curing rate, the SLAC is not ideally suited for use with typical existing adhesive application apparatuses. This is because the two components react very quickly, causing the adhesive to gel and be unfit for application to a substrate. For this reason, the SLAC is formulated such that the isocyanate and polyol components are applied separately on two different substrates, instead of being premixed and applied on a carrier web as typically done in prior art processes.

In particular, the SLAC is formulated such the isocyanate component, Component A, can be uniformly applied to a surface of a first substrate and the polyol component, Component B, can be applied to a surface of a second substrate. The surface of the first substrate is then brought into contact with the surface of the second substrate to mix and react the two components, thereby forming a laminate. The adhesive composition is then curable.

### Isocyanate Component

The isocyanate component (an NCO-component), Component A, of the present invention includes, for example, any of the conventional isocyanate compounds known in the art of forming a polyurethane adhesive composition including, for example, an isocyanate monomer, an isocyanate prepolymer, a polyisocyanate, or mixtures thereof. A polyisocyanate can include for example aliphatic polyisocyanates, cycloaliphatic polyisocyanates, aromatic polyisocyanates, isocyanate prepolymers, and combinations of two or more thereof. As used herein, a “polyisocyanate” is any compound that contains two or more isocyanate groups. An “aliphatic polyisocyanate” is a polyisocyanate that contains no aromatic rings. A “cycloaliphatic polyisocyanate” is a subset of aliphatic polyisocyanates, wherein the chemical chain is ring-structured. An “aromatic polyisocyanate” is a polyisocyanate that contains one or more aromatic rings.

Examples of suitable aliphatic polyisocyanates and cycloaliphatic polyisocyanates useful in the present invention include, but are not limited to, cyclohexane diisocyanate, methylcyclohexane diisocyanate, ethylcyclohexane diisocyanate, propylcyclohexane diisocyanate, methyldiethylcyclohexane diisocyanate, propane diisocyanate, butane diisocyanate, pentane diisocyanate, hexane diisocyanate, heptane diisocyanate, octane diisocyanate, nonane diisocyanate, nonane triisocyanate, such as 4-isocyanatomethyl-1,8-octane diisocyanate (TIN), decane di- and triisocyanate, undecane di- and triisocyanate and dodecane di- and triisocyanate, hexamethylene diisocyanate (HDI), isophorone diisocyanate (IPDI), diisocyanatodicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI), xylylene diisocyanate (XDI), 1,4- or 1,3-bis(isocyallatornethyfloyclohexalle (H₆XDI), tetramethylxylylene diisocyanate, and dimers, trimers, derivatives and mixtures of the of two or more thereof. Suitable aliphatic polyisocyanates and cycloaliphatic polyisocyanates useful in the present invention also include, for example, XDI-based polyisocyanate, H₆XDI-based polyisocyanate, XDI isocyanurate, HDI-based polyisocyanate, H₁₂MDI-based polyisocyanate, IPDI-based polyisocyanate, and mixtures of two or more thereof.

In one preferred embodiment, the aliphatic isocyanate component useful in the present invention includes, for example, XDI based polyisocyanate, HDI-based polyisocyanate and mixtures thereof.

Exemplary of some of the commercial products of aliphatic isocyanate components useful in the present invention include, for example, Desmodur® N 3200 and Desmodur® N 3300, available from The Covestro Company; and mixtures thereof.

The aromatic isocyanate component useful as Component A in the present invention can include one or more polyisocyanate compounds including, but are not limited to, for example, 1,3- and 1,4-phenylene diisocyanate; 1,5-naphthylene diisocyanate; 2,6-tolulene diisocyanate (2,6-TDI); 2,4-tolulene diisocyanate (2,4-TDI); 2,4′-diphenylmethane diisocyanate (2,4′-MDI); 4,4′-diphenylmethane diisocyanate (4,4′-MDI); 3,3′-dimethyl-4,4′-biphenyldiisocyanate (TODI) and isomers thereof; polymeric isocyanates; and mixtures of two or more thereof.

Exemplary of some of the commercial aromatic isocyanate components useful in the present invention can include, for example, ISONATE™ 125 M, ISONATE™ 50 OP, and ISONATE™ 143L, available from The Dow Chemical Company; DESMODUR® E 2200/76, available from The Covestro Company; and mixtures thereof. One of the advantageous properties exhibited by the aromatic isocyanate component of the present invention includes, for example, providing an adhesive which can be fast cured.

Also, isocyanate compounds suitable for use, as Component A, according to the present disclosure include, for example, isocyanate prepolymers. “Isocyanate prepolymers” are reaction products of (a) a polyisocyanate component and (b) a polyol component at a stoichiometry ratio (NCO/OH) of greater than (>) 2.0 in one embodiment, from 3.0 to 10.0 in another embodiment, and from 4.0 to 7.0 in still another embodiment.

The polyisocyanate, component (a), is selected, for example, from aromatic polyisocyanates, aliphatic polyisocyanates, cycloaliphatic polyisocyanates, and mixtures thereof, as described above. Suitable polyol components, component (b), that can react with the polyisocyanates to form the isocyanate prepolymers, also known as “polyurethane prepolymers” include, for example, compounds with hydroxyl groups, amino groups, and thio groups. The polyol component that can react with the polyisocyanate component to form the isocyanate prepolymers useful in the present invention include, for example, a polyether polyol, a polyester polyol, a polycaprolactone polyol, a polyacrylate, a polycarbonates polyol, a natural oil-based polyol, and mixtures of two or more thereof.

The polyol component that can react with the polyisocyanate to form the isocyanate prepolymer useful in the present invention can also be characterized by the isocyanate reactive component's hydroxyl number and hydroxyl group functionality. “Hydroxyl number”, “OH#” or “hydroxyl value” is a measure of the content of free hydroxyl groups in a chemical substance. The hydroxyl number is the number of milligrams of potassium hydroxide (KOH) required to neutralize the acetic acid taken up on acetylation of one gram of a chemical substance that contains free hydroxyl groups. Hydroxyl number (OHN) is usually expressed as milligrams of potassium hydroxide per gram (mg KOH/g) of the chemical substance. The hydroxyl number is determined in accordance with DIN 53240.

“Hydroxyl group functionality” is the number of hydroxyl groups present in one molecule of a compound. Hydroxyl group functionality is measured in accordance with ASTM D4274-16 with results reported as an integer of from 1 or more in one embodiment and from 1 to 6 in another embodiment. In some embodiments, the average hydroxyl group functionality of the polyol component can be, for example, from 1.0 to 6.0 in one embodiment, from 1.8 to 4.0 in another embodiment, and from 2.0 to 3.0 in still another embodiment.

A compound having isocyanate groups, such as Component A of the present invention, can also be characterized by a weight percentage of isocyanate groups (NCO) based on a total weight of the compound. The weight percentage of isocyanate groups is termed “% NCO” and is measured in accordance with ASTM D2572-97. For example, the NCO content of Component A is 7% or more in one embodiment; and 10% or more in another embodiment. In still another embodiment, the NCO content of component (a) is 30% or less; and 25% or less in yet another embodiment.

Additional isocyanate-containing compounds suitable for use according to the present invention include, but are not limited to, 4-methyl-cyclohexane 1,3-diisocyanate; 2-butyl-2-ethylpentamethylene diisocyanate; 3(4)-isocyanatomethyl-1-methylcyclohexyl isocyanate; 2-isocyanatopropylcyclohexyl isocyanate; 2,4′-methylenebis(cyclohexyl) diisocyanate; 1,4-diisocyanato-4-methyl-pentane, and mixtures of two or more thereof.

In some embodiments, one or more of the above-described isocyanate compounds can be added, in a predetermined amount, to the components in Component A, or to the components in Component B, or to both Component A and Component B.

### Polyol Component

In the present invention, the Component B is a polyol component comprising a combination, mixture or blend of: (Bi) at least one amine-initiated polyol; (Bii) at least one aliphatic polyester polyol; and (Biii) at least one polyether polyol; and other optional components or additives if desired. The concentrations of (Bi)-(Biii) are sufficiently high enough to produce an adhesive composition that can be processed through a one-shot lamination process and that can produce a laminate with a good adhesion appearance, i.e., a laminate without defects such as bubbles and orange peeling at high (e.g., greater than 200 m/min) lamination line speeds. Other advantages that the SLAC of the present invention has over the heretofore known solventless adhesive systems include for example: (1) good adhesion performance; and (2) a fast curing property. Also, the SLAC of the present invention is useful in a one-shot lamination process for making a multilayer laminate having good heat resistance and good chemical resistance properties which are properties suitably imparted onto a packaging article made from the laminate.

Inclusion of the amine-initiated polyol in the polyol component provides for higher reactivity and faster curing than traditional polyols used in existing two component solventless adhesive compositions. The amine-initiated polyol comprises primary hydroxyl groups and a backbone incorporating at least one tertiary amine. In some embodiments, the polyol component can also comprise another type of polyol which is a non-amine-initiated polyol. Each polyol type may include one kind of polyol. Alternatively, each polyol type may include mixtures of different kinds of polyols. In some embodiments, one polyol type may be one kind of polyol whereas the other polyol type may be a mixture of different kinds of polyols. The amine-initiated polyol comprises primary hydroxyl groups and a backbone incorporating at least one tertiary amine. Amine-initiated polyols suitable for use according to the present invention are made by alkoxylating one or more amine initiators with one or more alkylene oxides.

In some embodiments, the amine-initiated polyol has the chemical structure of Structure (I):

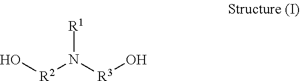

wherein R¹, R², and R³ are each independently organic groups. For instance, can each independently be a C₁-C₆ linear or branched alkyl group, can each independently comprise ether group and hydroxyl group, can each independently comprise tertiary amines and secondary amines.

The amine-initiated polyol comprises a functionality of from 2 to 12 in one embodiment, or from 3 to 10 in another embodiment, or from 4 to 8 in still another embodiment. As used with respect to the polyol component, “functionality” refers to the number of isocyanate reactive sites per molecule. Further, the amine-initiated polyol comprises a hydroxyl number of from 5 to 1,830 in one embodiment, or from 20 to 100 in another embodiment, or from 31 to 40 in still another embodiment. As used with respect to the polyol component, “hydroxyl number” is a measure of the amount of reactive hydroxyl groups available for reaction. This number is determined in a wet analytical method and is reported as the number of milligrams of potassium hydroxide equivalent to the hydroxyl groups found in one gram of the sample. The most commonly used methods to determine hydroxyl number are described in ASTM D 4274 D. Still further, the amine-initiated polyol comprises a viscosity at 25 degrees Celsius (° C.) of from 500 milliPascals second (mPa-s) to 20,000 mPa-s in one embodiment, or from 1,000 mPa-s to mPa-s in another embodiment, or from 1,500 mPa-s to 10,000 mPa-s in still another embodiment.

The amount of the amine-initiated polyol in the polyol component is, by weight based on the weight of the polyol component, Component B, (i.e., the total weight of the polyol component), at least 2 wt % in one embodiment, or at least 4 wt %, in another embodiment, or at least 6 wt % in still another embodiment. The amount of the at least one amine-initiated polyol in the adhesive composition is, by weight based on the weight of the polyol component, not to exceed 60 wt % in one embodiment, or not to exceed 50 wt % in another embodiment, or not to exceed 40 wt % in still another embodiment, based on the total weight amount of the polyol components in Component B.

The aliphatic polyester polyol compound, component (Bii), useful in the SLAC of the present invention can include, for example polyester polyols derived from aliphatic polycarboxylic acids and polyols. In one embodiment, the polyester polyol compound suitable for use in the polyol co-reactant component (Component B), can be selected, for example, from polyester polyols having a number average molecular weight (Mₙ) of not more than 4,000 g/mol. In addition, the suitable polyester polyols can have an OH functionality (f) of ≥1.8 to ≤3 (i.e., 1.8≤f≤3) and an OH number between 30 mg KOH/g to 200 mg KOH/g. The “OH number” or “OH#”, as used herein, is characterized by the milligrams of potassium hydroxide equivalent to the hydroxyl content in one gram of polyol.

In another embodiment, the polyester polyol compound suitable for use in the SLAC can include, for example, polycondensates of diols and also, optionally, polyols (e.g., triols, tetraols), and mixtures thereof; and of aliphatic dicarboxylic acids, and mixtures thereof. In another embodiment, the polyester polyol compound can also be derived from aliphatic dicarboxylic acids, their corresponding anhydrides, or corresponding esters of lower alcohols.

Suitable diols useful in the present invention can include, but are not limited to, ethylene glycol; butylene glycol; diethylene glycol; 1,2-propanediol; 1,3-propanediol; 1,3-butanediol; 1,4-butanediol; 1,6-hexanediol; 2-methyl -1,3-propanediol; neopentyl glycol; and mixtures thereof. In one embodiment, to achieve a polyester polyol having an OH functionality of >2, polyols having an OH functionality of 3 or >3 can optionally be included in the adhesive composition (e.g., trimethylolpropane, glycerol, erythritol, or pentaerythritol).

Suitable aliphatic dicarboxylic acids useful in the present invention can include, but are not limited to cyclohexane dicarboxylic acid, adipic acid, azelaic acid, sebacic acid, glutaric acid, maleic acid, fumaric acid, itaconic acid, malonic acid, suberic acid, 2-methyl succinic acid, 3,3-diethyl glutaric acid, 2,2-dimethyl succinic acid, trimellitic acid, and mixtures thereof. Anhydrides of such acids may also be used. Further, monocarboxylic acids, such as benzoic acid and hexane carboxylic acid, should be minimized or excluded from the compositions of the present invention.

The amount of the aliphatic polyester polyol compound, component (Bii), in the polyol component, Component B, can be generally in the range of from 5 wt % to 50 wt % in one embodiment; from 8 wt % to 40 wt % in another embodiment; and from 10 wt % to 30 wt % in still another embodiment, based on the polyol components, Component B.

In general, the Mₙ of the polyester polyol compound can be from >400 g/mol in one embodiment, >500 g/mol in another embodiment, >600 g/mol in still another embodiment, and >800 g/mol in yet another embodiment. Also, the Mₙ of the polyester polyol compound can be <3,000 g/mol in one embodiment, <2,500 g/mol in another embodiment; and <2,000 g/mol in still another embodiment.

The polyether polyol component, component (Biii), useful in the present invention includes, but is not limited to, for example, polypropylene glycols, polytetramethylene ether glycols, polybutylene oxide-based polyols, and copolymers thereof; and mixtures thereof. Generally, the polyether polyol has a Mₙ of <1,500 g/mol in one embodiment, <1,000 g/mol in another embodiment, and from 50 g/mol to 1,500 g/mol in still another embodiment. In another embodiment, the polyether polyol has a Mₙ of from 150 g/mol to 1,500 g/mol and a functionality of from 2.0 to 6.0.

Exemplary of suitable polypropylene glycols useful in the present invention include, but are not limited to, for example, polyols based on propylene oxide, ethylene oxide, or mixture of them with initiators selected from propylene glycol, dipropylene glycol, sorbitol, sucrose, glycerin, and/or mixtures thereof. For example, the polypropylene glycols can include VORANOL™, available from The Dow Chemical Company; PLURACOL™, available from the BASF Company; POLY-G™, POLY-L™, and POLY-Q™, available from Lonza; and ACCLAIM™ available from Covestro; and mixtures thereof. In one preferred embodiment, polypropylene glycols with a functionality of between 2 to 6 and a Mₙ of from 150 g/mol to 1,500 g/mol are used.

Exemplary of suitable polytetramethylene ether glycols useful in the present invention include, but are not limited to, for example, POLYTHF™ available from the BASF Company; TERTHANE™ available from Invista; PTMG™ available from Mitsubishi; and PTG™ available from Dairen; and mixtures thereof. In one preferred embodiment, polytetramethylene ether glycols with a functionality of between 2 to 6 and a Mₙ of from 250 g/mol to 1,500 g/mol are used.

Exemplary of suitable polybutylene oxide-based polyols useful in the present invention include, but are not limited to, for example, polybutylene oxide homopolymer polyols, polybutylene oxide-polypropylene oxide copolymer polyols, and polybutylene oxide-polyethylene oxide copolymer polyols; and mixtures thereof. In one preferred embodiment, polybutylene oxide-based polyols with a functionality of from 2.0 to 6.0 and a Mn of from 150 g/mol to 1,500 g/mol are used.

In other embodiments, the polyether polyols useful in the present invention, include, but are not limited to, for example, low molecular weight glycols, including, but not limited to, for example, ethylene glycol, diethylene glycol, triethylene glycol, propylene glycol, trimethylene glycol, 1,3-butanediol, 1,4-butanediol, 1,6-hexanediol, trimethylolpropane, triisopropanolamine, neopentyl glycol; and mixtures thereof.

Generally, the amount of the polyether polyol, component (Biii), used in the present invention is from 20 wt % to 80 wt % in one embodiment, from 30 wt % to 70 wt % in another embodiment, and from 40 wt % to 60 wt % in still another embodiment, based on the total components in the polyol component, Component B.

In some embodiments, in addition to Components (Bi)-(Biii), any number of other different polyols may optionally be included in the adhesive composition, e.g., in the polyol component. Examples of other polyols, different from Components (Bi)-(Biii), include, but are not limited to, non-amine-initiated polyols, other polyester polyols, other polyether polyols, polycarbonate polyols, polyacrylate polyols, polycaprolactone polyols, polyolefin polyols, natural oil polyols, and combinations of two or more thereof. In some embodiments, the other polyol, when used, has a viscosity at 25° C. of, for example, from 30 mPa-s to 40,000 mPa-s in one embodiment, or from 50 mPa-s to 30,000 mPa-s in another embodiment, or from 70 mPa-s to 20,000 mPa-s in still another embodiment, as measured by the method of ASTM D2196. In one preferred embodiment, the other polyol, when used, has a viscosity of 100 mPa-s to mPa-s at 25° C., as measured by the method of ASTM D2196.

The amount of the other polyol in the adhesive composition, when used, is at least 0 wt % in one embodiment, or at least 5 wt % in another embodiment, or at least 10 wt % in still another embodiment. The amount of the other polyol in the adhesive composition, when used, is not to exceed 40 wt % in one embodiment, or not to exceed 30 wt % in another embodiment, or not to exceed 20 wt % in still another embodiment, based on the total components in the polyol component, Component B.

In some embodiments, one or more of the above-described polyol compounds can be added, in a predetermined amount, to the components in Component A, or to the components in Component B, or to both Component A and Component B.

In some embodiments, an additive can optionally be included in the SLAC of the present invention. Examples of such additives include, but are not limited to, tackifiers, plasticizers, rheology modifiers, adhesion promoters, antioxidants, fillers, colorants, surfactants, solvents, and combinations of two or more thereof.

### Adhesive Formation

In one broad embodiment, the SLAC of the present invention is prepared by combining the at least one isocyanate component, Component A; the at least one polyol component, Component B; and any optional ingredients or additives, if desired. Generally, the “combining” step of Components A and B, which forms the reactive adhesive composition of the present invention, is carried out during the one-shot lamination process operating at high line speeds (e.g., greater than or equal to 200 m/min). In the one-shot lamination process, a process step is used to bring a first film containing Component A in contact with a second film containing Component B such that the two components (co-reactants) come together to form a uniform and homogeneous reactive SLAC interposed between the first and second film.

Once the two components (co-reactants) contact each other a reactive SLAC interposed between the first and second film is formed. The resultant SLAC, made according to the process described above, is then used to prepare a laminate, which in turn, is used to make a laminate article or product. Some of the advantageous properties exhibited by the resulting SLAC containing the CR component of the present invention used in a one-shot lamination process to form a laminate include, for example: (1) a laminate's “time to slit” can be reduced to, for example, 2 hours (hr) after lamination (which is a time that is down from 2-3 days when a general conventional purpose adhesive is used); and (2) a laminate's “time to delivery” can be reduced to, for example, 2 days (which is a time that is down from 5-7 days when a general conventional purpose adhesive is used).

### Laminate Formation

In a broad embodiment, the laminate structure of the present invention includes the combination of at least two film layer substrates adhered or bonded together by an adhesive layer formed inbetween the two substrates wherein the adhesive layer is formed by using the SLAC of the present invention. For example, the laminate structure includes: (a) a first film substrate; (b) a second film substrate; and (c) a layer of the SLAC described above for binding the layers (a) and (b). One or more other optional film substrates can be used to produce a multilayer laminate structure, if desired.

In the present invention, the laminate structure is produced by applying the two separate components of the adhesive to two separate film substrates, for example, Component A is applied the first film substrate and Component B is applied to the second film substrate. Then, the two film substrates are brought together to have the two components contact each other to form the SLAC.

It is contemplated that the isocyanate component and the polyol component of the SLAC are formulated separately and stored until it is desired to form a laminate structure. In one preferred embodiment, the isocyanate component and polyol component are in a liquid state at 25° C. Even if the components are solid at 25° C., it is acceptable to heat the components as necessary to put them into a liquid state. As the pot-life of the adhesive composition is decoupled from the curing process, the components can be separately stored indefinitely.

A laminate comprising the SLAC can be formed by applying the isocyanate and polyol components of the adhesive composition separately to two different substrates, such as two films. As used herein, a “film” is any structure that is 0.5 millimeters (mm) or less in one dimension and is 1 centimeter (cm) or more in both of the other two dimensions. A “polymer film” is a film that is made of a polymer or mixture of polymers. The composition of a polymer film is, typically, 80 percent by weight or more by weight of one or more polymers.

For instance, a layer of the isocyanate component is applied to a surface of a first substrate. In one general embodiment, the thickness of the layer of the isocyanate component on the first substrate is from 0.5 microns (μm) to 1.5 μm. A layer of the polyol component is applied to a surface of a second substrate. In one general embodiment, the thickness of the layer of the polyol component on the second substrate is from 0.5 μm to 1.5 μm. By controlling the thickness of the layers applied to each substrate, the ratio of the components can be controlled. In some embodiments, the mix ratio of the isocyanate component to the polyol component in the final SLAC can be 100:100 in one embodiment, or 100:90 in another embodiment, or 100:80 in still another embodiment. The SLAC of the present invention is more forgiving than traditional adhesives and can accommodate some coating weight error (e.g., up to about 10% coating weight error).

The surfaces of the first and second substrates are then run through a device for applying external pressure to the first and second substrates, such as nip roller. Bringing the isocyanate component and polyol component together forms a curable adhesive mixture layer. When the surfaces of the first and second substrates are brought together, the thickness of the curable adhesive mixture layer is 1 μm to 5 μm in one embodiment. The isocyanate component and polyol component begin mixing and reacting when the first and second substrates are brought together and the components come into contact with each other. This marks the beginning of the curing process.

Further mixing and reacting is accomplished as the first and second substrates are run through various other rollers and ultimately to a rewind roller. The further mixing and reacting occurs as the first and second substrates pass through rollers because the substrates each take longer or shorter paths than the other substrate across each roller. In this way, the two substrates move relative to one another, mixing the components on the respective substrates. Arrangements of such rollers in an application apparatus are commonly known in the art. The curable mixture is then cured or allowed to cure.

In a preferred embodiment, the process for producing a multilayer laminate structure includes, for example, the steps of: (I) providing at least one first film substrate; (II) providing at least one second film substrate; (III) providing, as separate components, the isocyanate component, Component A, and the polyol component, Component B, of the SLAC; (IV) applying the isocyanate component of the SLAC to at least a portion of the inside surface of the at least one first film substrate to form a coating layer of the isocyanate component on the inside surface of the at least one first film substrate; (V) applying the polyol component of the SLAC of the present invention to at least a portion of the inside surface of the at least one second film substrate to form a coating layer of the polyol component on the inside surface of the at least one second film substrate; (VI) bringing the first and second film substrates together such that the coating layer of the isocyanate component on the inside surface of the at least one first film substrate comes into contact with the coating layer of the polyol component on the inside surface of the at least one second film substrate to form a combined adhesive layer of the SLAC inbetween the first and second substrates and to form an uncured multilayer laminate structure; and (VII) curing the SLAC disposed inbetween the first and second substrates to bond the first and second substates together and to form a cured bonded multilayer laminate structure.

The application step (IV) of the above process can be carried out, at room temperature, by applying the isocyanate component of the SLAC on at least a portion of one side of the first film substrate such as the inside or internal surface of the first film substrate with the outside or external surface of the first film substrate having no isocyanate component applied thereto. Additionally, the application step (V) of the above process can be carried out by applying the polyol component of the SLAC on at least a portion of one side of second film substrate such as the inside or internal surface of the second film substrate with the outside or external surface of the second film substrate having no polyol component applied thereto. Then, the inside surface of the first film substrate is brought in contact with the inside surface of the second film substrate according to step (VI) of the above process to form a layer of the SLAC disposed in between the first and second substrate layers and to form a layered laminate structure. Step (VII) includes heating the layered laminate structure of step (VI) to a temperature sufficient to cure the SLAC layer such that the first and second substrates are bonded together to form a cured multilayer laminate structure.

The application steps of the components of the components of the SLAC, steps (IV) and (V), can be carried out by conventional means known in the art of applying adhesive compositions or formulations to films and substrates.

In step (VI) of the above process, the isocyanate component of the SLAC which is coated on the first film substrate is contacted with the polyol component of the SLAC which is coated on the second film layer such that the isocyanate and polyol components intermix with each other to form a layer of the SLAC in between the first and second substrates and to form an uncured multilayer laminate structure.

After the contacting step, step (VI), of the above described process wherein the at least first film substrate and the at least second film substrate are contacted together, the SLAC layer, disposed inbetween the two substrates, is cured, according to step (VII) of the above process. The curing of the SLAC effectuates a bond between the first film substrate and the second film substrate to form a cured multilayer laminate.

Suitable substrates in the laminate structure include films such as polymeric barrier films including, but not limited to, polyethylene-based films, polyamide-based films, and ethylene vinyl alcohol-based films. Some films optionally have a surface on which an image is printed with ink which may be in contact with the adhesive composition. The substrates are layered to form a laminate structure, with the adhesive composition of the present invention adhering one or more of the substrates together.

### Laminate Structure

One of the advantages of the SLAC of the present invention is the resulting SLAC can readily be used to produce a multilayer film by laminating various types of films using the SLAC without the limitations of the previously known adhesive formulations. For example, the SLAC can be used for laminating various plastic films, metal vapor deposited films, aluminum foils, and other metalized and barrier laminate structures to produce a composite film useful for packaging materials such as foods, medicines, detergents, and the like. For example, the SLAC of the present invention is used for producing a multilayer laminate structure, which in turn, is used to manufacture a product or article such as a pouch, a sachet, a stand-up pouch, or other bag member or container, and in particular a container which is used for packaging foods.

In one embodiment, the laminate structure includes: (a) a first film substrate; (b) a second film substrate; and (c) a layer of the SLAC described above interposed between the first film substrate and the second film substrate for binding the film substrates (a) and (b). Suitable substrates in the laminate structure include polymer films, metal foil, and metal-coated (metallized) polymer films. Suitable polymeric barrier films including, but not limited to, polyethylene-based films, polyamide-based films, and ethylene vinyl alcohol-based films. Some films optionally have a surface on which an image is printed with ink which may be in contact with the adhesive composition. The substrates are layered to form a laminate structure, with an adhesive composition according to this disclosure adhering one or more of the substrates together.

### EXAMPLES

The following examples are presented to further illustrate the present invention in detail but are not to be construed as limiting the scope of the claims. Unless otherwise indicated, all parts and percentages are by weight.

Various materials used in the Inventive Examples (Inv. Ex.) and the Comparative Examples (Comp. Ex.), which follow, are explained in Table I.

TABLE I
Raw Materials

| Ingredient | Brief Description | Supplier |
|---|---|---|
| ISONATE ™ M 125 | Isocyanate | Dow |
| VORANOL ™ CP755 | Polyether polyol, OH = 238 | Dow |
| IP 9001 | Polyester polyol, OH = 213 | Dow |
| SPECFLEX ACTIVE ™ 2306 | Polyether polyol, OH = 37 | Dow |
| BESTER ™ 101 | Polyester polyol, OH = 112 | Dow |
| VORANOL ™ CP450 | Polyether polyol, OH = 380 | Dow |
| SYMBIEX ™ 100 | Polyisocyanate | Dow |
| SYMBIEX ™ 200 | Polyisocyanate | Dow |
| SYMBIEX ™ CR001 | Polyol, OH = 134 | Dow |
| SYMBIEX ™ CR002 | Polyol, OH = 134 | Dow |

### Polyol Component B

The co-reactant, Component B used in the SLAC of the present invention, referred to herein as “inventive polyol component” (“IPC”), was prepared according to the ingredients described in Table II. BESTER™ 101, ISONATE™ M 125 and VORANOL™ CP755 were charged into a reactor and then the contents of the reactor were agitated (mixed) with heating. The temperature in the reactor was held at a temperature of 70-80° C. for 2 hr. After 2 hr, the resulting mixture in the reactor was cooled down to 40° C., and then IP9001, VORANOL™ CP450 and SPECFLEX ACTIVE™ 2306 were charged into the reactor. The resulting mixture in the reactor was stirred for 30 min; and after 30 min, the resulting mixture formed the IPC. The IPC produced has a OH number of 136 and a viscosity at 25° C. of 14,000 mPa-s.

TABLE II
IPC Formulation

| Ingredient | % w/w |
|---|---|
| BESTER ™ 101 | 14.83 |
| ISONATE ™ M 125 | 9.40 |
| VORANOL ™ CP755 | 50.75 |
| IP 9001 | 10.82 |
| VORANOL ™ CP450 | 4.00 |
| SPECFLEX ACTIVE ™ 2306 | 10.20 |
| Total | 100.00 |

### Laminate Substrates

The laminates produced as described in the Examples herein are made with one or more of the following films substrates: (1) unprinted PET 12 μm (PET); (2) aluminum foil 9 μm (Al); and (3) barrier polymeric films comprising co-extruded polyethylene with ethyl vinyl alcohol 50 μm with a 5 μm layer of EVOH containing 32% of ethylene co-monomer (PE-EVOH) or polyamide 15 μm (OPA).

The barrier films were assembled to produce the laminates; and the barrier films can be organized in two main categories: (1) metallized laminates: Al/PET (unprinted, full printed or Printed windows); and (2) polymeric barrier laminates: PE-EVOH/PET and PE-EVOH/OPA.

The laminates described in Table III were prepared using the following substrates: (1) aluminum foil/PET, (2) PET/PE-EVOH, and (3) OPA/PE-EVOH.

### Comparative Examples A-E

The reference adhesive formulations used in preparing the laminates of Comp. Ex. A (Ref.) and Comp. Ex. C described in Table III contains CR001 as a co-reactant; and the adhesive formulations used in preparing the laminates of Comp. Ex. B, D and E uses CR002 as a co-reactant. The adhesive formulations used Comp. Ex. A, B, C, D and E using CR001 and CR002 contain aromatic polyester polyol, but do not contain aliphatic polyester polyol. The adhesive formulations used in preparing the laminates of Comp. Ex. B, D and E, in addition to an aromatic polyester polyol, contains a silicone-based additive; and the adhesive formulations of Comp. Ex. B, D and E need to be re-dispersed immediately before the adhesive formulations are used in a one-shot lamination process.

### Examples 1-5

The SLAC used in producing the laminates of Inv. Ex. 1-5 uses IPC as a co-reactant; no silicone-based additive is added to the SLAC; and no re-dispersion of the SLAC is required.

### Laminate Formation

Table III describes the laminates prepared using the adhesive components described in Tables I and II above. The laminate structures comprising the adhesive systems described in Table III are prepared on a Nordmeccanica DUPLEX ONE-SHOT™ laminator having the following machine parameters: temperature at dosing gap of 45° C.; temperature at application roll of 55° C.; temperature at nip roll of 55° C.; nip pressure of 2.5 Newtons (N); lay-on pressure of 1.5 N; rewind tension of 160 N; hardness at nip roll of 90 shore. As indicated in Table III, the OH Component (i.e., the polyol component) is applied to the Laminate OH Part (e.g., a first substrate), and the NCO Component (i.e., the isocyanate component) is applied to the Laminate NCO Part (e.g., a second substrate) prior to the two coated substrates being brought together for lamination. The two coated substrates are brought together to form laminates in a nipping station. The coat weight of each laminate is maintained at about 1.0 gram per square meter (g/m²). The metering temperature, application temperature, and nip temperature are 50° C., 50° C. and 65° C., respectively.

### Lamination Speed

The appearance of the laminates, produced via the one-shot lamination process and laminator, was visually inspected after production of the laminates. The highest lamination speed, as recorded on the speed monitor reading of the one-shot laminator, of the laminated structures was determined when the laminates did not show any visual defects, such as bubbles or orange peels. The laminates produced using the co-reactant of the present invention, IPC, showed good optics.

Table III describes the results of lamination speed of laminates produced from SLACs of the present invention containing IPC compared to the lamination speeds of other laminates produced from various adhesive formulations containing co-reactant CR001 or CR002.

TABLE III
Laminates and Lamination Speed

| | | | | | |
|---|---|---|---|---|---|
| | | | | | Highest |
| | | | | | Lamination |
| | | | | | Speed with |
| | OH | Laminate | NCO | Laminate | Good Optics |
| Example No. | Component | OH Part | Component | NCO Part | (m/min) |

Metalized Laminates

| | | | | | |
|---|---|---|---|---|---|
| Comp. Ex. A (Ref.) | CR001 | Al | SYMBIEX ™ 100 | Unprinted PET | 250 |
| Comp. Ex. B | CR002 | Al | SYMBIEX ™ 200 | Unprinted PET | 300 |
| Inv. Ex. 1 | IPC | Al | SYMBIEX ™ 100 | Unprinted PET | 300 |
| Inv. Ex. 2 | IPC | Al | SYMBIEX ™ 100 | Printed PET | 300 |
| Inv. Ex. 3 | IPC | Al | SYMBIEX ™ 200 | Unprinted PET | 300 |

High Barrier Laminates

| | | | | | |
|---|---|---|---|---|---|
| Comp. Ex. C (Ref.) | CR001 | PE-EVOH | SYMBIEX ™ 100 | Printed PET Window | <150 |
| Comp. Ex. D | CR002 | PE-EVOH | SYMBIEX ™ 100 | Unprinted PET | <150 |
| Comp. Ex. E | CR002 | PE-EVOH | SYMBIEX ™ 200 | Unprinted PET | 300 |
| Inv. Ex. 4 | IPC | PE-EVOH | SYMBIEX ™ 200 | Unprinted PET | 300 |
| Inv. Ex. 5 | IPC | PE-EVOH | SYMBIEX ™ 200 | OPA | 300 |

The metallized laminates, i.e., Al/PET (unprinted, full printed or printed windows), and the polymeric barrier laminates, i.e., PE-EVOH/PET and PE-EVOH/OPA, were limited in terms of lamination speed with use of the adhesive systems of Comp. Ex. A and B, due to the creation of defects. The defects created are of different nature for each type of laminate structure; and can be described as follows: For the metallized laminate structures: a wetting failure and an air entrainment are the two main causes of the defects observed at higher lamination line speeds; and for the polymeric barrier laminate structures: a wetting failure, an air entrainment, and a CO₂ formation are the three main causes of the defects observed (even at lower lamination speeds).

The adhesive systems containing the CR002 co-reactant includes the use of a silicone-based additive that is not stable in the adhesive formulation of Comp. Ex. B, D and E; and therefore, the adhesive formulation of Comp. Ex. B, D and E requires the formulations to be re-dispersed immediately before the formulation is used in the lamination process.

As described in Table III, laminates produced using the SLAC of the present invention containing co-reactant IPC allows improved lamination speeds on metalized films and on high barrier films, without using a defoamer, a wetting agent, or other additives in the solventless laminating adhesive formulation of the present invention.

What is claimed is:

1. A two-component solventless laminating adhesive composition comprising:
(A) at least one isocyanate component comprising at least one isocyanate; and
(B) at least one polyol component comprising:
(Bi) at least one amine-initiated polyol;
(Bii) at least one aliphatic polyester polyol; and
(Biii) at least one polyether polyol.

2. The two-component solventless laminating adhesive composition of claim 1, wherein the at least one aliphatic polyester polyol is a compound derived from aliphatic polycarboxylic acids and polyols; and wherein the amine-initiated polyol has the chemical structure of Structure (I); 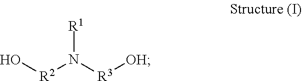
and wherein the at least one polyether polyol is a compound selected from the group consisting of polypropylene glycols, polytetramethylene ether glycols, polybutylene oxide-based polyols, and copolymers thereof; and mixtures thereof.

3. The two-component solventless laminating adhesive composition of claim 1, wherein the concentration of the at least one amine-initiated polyol is from 6 weight percent to weight percent; wherein the concentration of the at least one aliphatic polyester polyol is from 10 weight percent to 30 weight percent; and wherein the concentration of the at least one polyether polyol is from 40 weight percent to 60 weight percent.

4. The two-component solventless laminating adhesive composition of claim 1, wherein the ratio of A:B is from 100:100 to 100:80.

5. A process of making a two-component solventless laminating adhesive composition comprising the step of admixing:
(A) at least one isocyanate component comprising at least one isocyanate; and
(B) at least one polyol component comprising a polyol composition comprising:
(Bi) at least one amine-initiated polyol;
(Bii) at least one aliphatic polyester polyol; and
(Biii) at least one polyether polyol.

6. A multi-layer laminate film composite structure comprising:
(a) at least a first substrate layer;
(b) at least a second substrate layer; and
(c) a layer of the adhesive composition of claim 1 disposed inbetween the first substrate layer and the second substrate layer; wherein the adhesive is cured to bond the first substrate layer to the second substrate layer.

7. A process for producing the multi-layer laminate structure of claim 6 comprising the steps of:
(I) providing at least a first substrate;
(II) providing at least a second substrate;
(III) providing a solventless adhesive laminating composition of claim 1;
(IV) applying a first layer of the at least one isocyanate component to at least a portion of one surface of the first substrate to form a film layer of the at least one isocyanate component disposed on the first substrate;
(V) applying a coating layer of the at least one polyol component to at least a portion of one surface of the second substrate to form a film layer of the polyol component disposed on the second substrate;
(VI) bringing the layer of the at least one isocyanate component on the surface of the first substrate into contact with the coated layer of the at least one polyol component on the surface of the second substrate forming a combined adhesive formulation layer comprising the at least one isocyanate component and the polyol component in between the first and second substrates and forming a layered laminate structure; and
(VII) curing the adhesive formulation in between the first and second substrates to attach, via the cured adhesive layer, the first substrate to the second substrate such that a bonded multilayer laminate structure is formed.

8. A laminate structure comprising the two-component solventless laminating adhesive composition according to claim 1.

9. The laminate structure of claim 8, further comprising a polymeric barrier substrate or a metal/metalized substrate.
